(19) United States
(12) Patent Application Publication
(10) Pub. No.: US 2024/0002611 A1
(43) Pub. Date: Jan. 4, 2024

(54) MULTIFUNCTIONAL RESINS FOR 3D PRINTED MATERIALS AND METHODS OF MAKING SAME

(71) Applicant: Meta Platforms Technologies, LLC, Menlo Park, CA (US)

(72) Inventors: Steven Adelmund, Seattle, WA (US); Thomas John Farrell Wallin, Redmond, WA (US)

(73) Assignee: Meta Platforms Technologies, LLC, Menlo Park, CA (US)

(21) Appl. No.: 18/342,418

(22) Filed: Jun. 27, 2023

Related U.S. Application Data
(60) Provisional application No. 63/367,428, filed on Jun. 30, 2022.

(51) Int. Cl. C08J 3/28; C08J 3/24

(52) U.S. Cl. CPC C08J 3/28; C08J 2300/00; C08J 3/247

(57) ABSTRACT

Described herein are polymers prepared from multifunctional monomers, according to a defined sequential reaction scheme in a one-pot system, along with methods of making the same. Also described herein are tunable, 3D printed materials prepared from resin mixtures described herein. The 3D printed materials possess a large range of material properties, including tunable elastic moduli properties.

### CROSS-REFERENCE TO PRIORITY APPLICATION

This application claims the benefit of and priority to U.S. Provisional Patent Application No. 63/367,428, filed Jun. 30, 2022, the contents of which are incorporated herein by reference in its entirety.

### TECHNICAL FIELD

Polymers prepared from multifunctional monomers, according to a defined sequential reaction scheme in a one-pot system, are provided herein along with methods of making the same. Also provided herein are tunable, 3D printed materials prepared from resin mixtures described herein.

### BACKGROUND

Conventional resin exchange methods or other means that control the deposition of liquid precursor can allow for multi-material fabrication. However, these techniques require multiple resin stocks and cleaning steps, which drastically reduce manufacturing speeds. The art has explored the methodology needed to construct two-stage polymers and their potential application in shape memory materials, holographic materials, impression and imprint materials, microarrays, adhesives, etc. However, typical sequential polymerizations usually utilize either a single photo trigger (at a certain wavelength) or a combined thermal/photo trigger to control the network formation using two crosslinking reactions. Currently, there are a few examples of N=2 photochemistry systems that can coexist within the same material, including light intensity controlled multimaterials and wavelength-selective polymerization processes. However, these examples suffer from many drawbacks, including that the resulting material is not stable under sunlight, and/or that the resulting material has a gradient of 1-4 orders of magnitude difference in modulus. The disclosure provides materials, methods, and processes to overcome these drawbacks.

### SUMMARY

Described herein is a method of polymerizing functionalized monomers, comprising subjecting an initial precursor resin mixture to an external stimulus, wherein the initial precursor resin mixture comprises one or more monomers, the one or more monomers comprising multifunctional monomers comprising two or more functional groups, to generate an intermediate stage reactive conversion having a spatially defined initial polymer length; and subjecting the intermediate stage reactive conversion to one or more polymerization and/or crosslinking stimuli, wherein the method steps are performed in a single reactor. Optionally, the two or more functional groups are each independently selected from the group consisting of an alkene, a thiol, an azide, a diene, or an oxime. The multifunctional monomer can comprise a bifunctional monomer, a trifunctional monomer, or a tetrafunctional monomer. Optionally, the initial precursor resin mixture can further comprise a single-functionality monomer having one functional group. The one functional group optionally can be selected from the group consisting of an alkene, a thiol, an azide, a diene, or an oxime.

In some cases, the external stimulus is a light source. Optionally, the external stimulus is a raised temperature (e.g., from about 50° C. to about 175° C.). Optionally, the external stimulus is ultrasound. The one or more polymerization and/or crosslinking stimuli can be a light source or can be a raised temperature (e.g., from about 50° C. to about 175° C.). In some cases, the polymerization and/or crosslinking stimuli comprise to at least two different raised temperatures. Optionally, the initial precursor resin mixture further comprises a photoinitiator. In some cases, intermediate stage reactive conversion is partially crosslinked or polymerized (e.g., from 0% to 100 percent, from 0.5 percent to 100%, or from 1% to 100% crosslinked or polymerized). The method can be a 3D printing method.

Further described herein is a polymeric material made according to the method described herein. Optionally, the polymeric material has a modulus gradient in a spatial direction. In some cases, the modulus gradient is an elastic modulus gradient. Optionally, the modulus ranges from 10² Pa to 10¹⁰ Pa.

The details of one or more embodiments are set forth in the drawings and the description below. Other features, objects, and advantages will be apparent from the description and drawings, and from the claims.

### BRIEF DESCRIPTION OF THE DRAWINGS

FIG. 1 illustrates the impact of short photo-exposures (X˜0), medium-length photo-exposures (X˜0.5), and long photo-exposures (X˜1) on the resulting structures. In FIG. 1, the triangle/hexagon reaction is initiated in stage one, the hexagon-circle and triangle-square reactions are second stage, and the circle-square reactions are third stage.

FIG. 2 illustrates the impact of short photo-exposures (X˜0), medium-length photo-exposures (X˜0.5), and long photo-exposures (X˜1) on the resulting structures.

### DETAILED DESCRIPTION

It is desirable to reduce friction between future devices and human input. One way to accomplish this is by closely matching the mechanical properties at the interface between human tissue and device. Human fat and muscle have elastic moduli of roughly 1 and 5 kPa, respectively, while plastics and silicon, likely materials for support and computation, are around 2 and 0.1 GPa, respectively.

A current single-pot, multi-modulus resin can achieve a range of 0.4 to 1600 MPa but have a far smaller working range of 700-1600 MPa due to the critical conversion required for use in a 3D printing process. Unlike 2D printing, the mechanical translations of the 3D printing process require the printed object to form a solid object to maintain structure in the intermediate steps. In the case of thermosetting polymers, this usually means have the precursor react enough to reach at least the critical conversion for gelation. This critical conversion for gelation can be calculated based on the functionality and concentrations of the first stage precursors (e.g., the groups that undergo photopolymerization). The material previously used in the field contained a trifunctional alkene (f˜3) with difunctional/tetrafunctional thiols (f˜2.2). This resulted in needing to obtain approximately 70% conversion to reach a gelled material that can maintain its own shape during printing. The immediate solutions would be to drastically increase the functionality of the alkene or thiol which can push the critical conversion for gelation down to 1% or less. A 3D printable resin that produces a large range of material properties would facilitate a seamless interface between human and machine. Described herein are such resins capable of facilitating a seamless interface between humans and machines.

Specifically, described herein is a single-pot system of multifunctional monomers with a defined sequential reaction scheme. Such systems, or formulations, include a mixture of multifunctional monomers or a mixture of multifunctional monomers with single functionality monomers. Importantly, an initial polymer length is defined spatially by controlling the extent of reaction in the first step (or immediately following green-body formation). Subsequent steps consume remaining reactive groups, resulting in a crosslinked material with controlled soft and stiff regions. Because the polymer length defined in the first step has a major impact on final material properties by occupying space and reducing the number of crosslinks in the material, a wide range of mechanical properties are accessible using the systems and methods described herein. As further described herein, suitable chemistry includes reactions such as thiol-ene, thiol-epoxy, epoxy-epoxy, azide-alkyne, Diels-Alder, and oxime based chemistry. Stimuli for spatial control over reaction conversion include, but are not limited to, heat, light, and/or ultrasound.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Unless defined otherwise, all technical and scientific terms used herein have the same meaning as is commonly understood by one of skill in the art to which this disclosure belongs. All patents and publications referred to herein are incorporated by reference in their entireties.

When ranges are used herein to describe, for example, physical or chemical properties such as molecular weight or chemical formulae, all combinations and subcombinations of ranges and specific embodiments therein are intended to be included. Use of the term “about” when referring to a number or a numerical range means that the number or numerical range referred to is an approximation within experimental variability (or within statistical experimental error), and thus the number or numerical range may vary. The variation is typically from 0% to 15%, or from 0% to 10%, or from 0% to 5% of the stated number or numerical range. The term “including” (and related terms such as “comprise” or “comprises” or “having” or “including”) includes those embodiments such as, for example, an embodiment of any composition of matter, method or process that “consist of” or “consist essentially of” the described features.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” means “when” or “upon” or “in response to determining” or “in response to detecting” or “in accordance with a determination that,” depending on the context. Similarly, the phrase “if it is determined” or “if [a stated condition or event] is detected” means “upon determining” or “in response to determining” or “upon detecting [the stated condition or event]” or “in response to detecting [the stated condition or event]” or “in accordance with a determination that [a stated condition or event] is detected,” depending on the context.

Described herein is a method of polymerizing functionalized monomers, comprising subjecting an initial precursor resin mixture to an external stimulus, wherein the initial precursor resin mixture comprises one or more monomers, the one or more monomers comprising multifunctional monomers comprising two or more functional groups, to generate an intermediate stage reactive conversion having a spatially defined initial polymer length; and subjecting the intermediate stage reactive conversion to one or more polymerization and/or crosslinking stimuli, wherein the method steps are performed in a single reactor. As used herein, a spatially defined initial polymer length means that in a local voxel, the material has a well-defined polymer length that is decoupled from the polymer length in neighboring pixels. Optionally, the two or more functional groups are each independently selected from the group consisting of an alkene, a thiol, an azide, a diene, or an oxime. The multifunctional monomer can comprise a bifunctional monomer, a trifunctional monomer, or a tetrafunctional monomer. Optionally, the initial precursor resin mixture can further comprise a single-functionality monomer having one functional group. The one functional group optionally can be selected from the group consisting of an alkene, a thiol, an azide, a diene, or an oxime.

In some cases, the external stimulus is a light source. Optionally, the external stimulus is a raised temperature (e.g., from about 50° C. to about 175° C.). Optionally, the external stimulus is ultrasound. The one or more polymerization and/or crosslinking stimuli can be a light source or can be a raised temperature (e.g., from about 50° C. to about 175° C.). In some cases, the polymerization and/or crosslinking stimuli comprise to at least two different raised temperatures. Optionally, the initial precursor resin mixture further comprises a photoinitiator. In some cases, the intermediate stage reactive conversion is partially crosslinked or polymerized (e.g., from 0% to 100 percent, from 0.5 percent to 100%, or from 1% to 100% crosslinked or polymerized). The method can be a 3D printing method.

Further described herein is a polymeric material made according to the method described herein. Optionally, the polymeric material has a modulus gradient in a spatial direction. In some cases, the modulus gradient is an elastic modulus gradient. Optionally, the modulus ranges from 10² Pa to 10¹⁰ Pa.

The term “light source” refers to any source of electromagnetic radiation of any wavelength, including without limitation an actinic radiation. In some embodiments, a light source can be a laser of a particular wavelength.

The term “photoinitiating light source” refers to a light source that activates a photoinitiator, a photoactive polymerizable material, or both. Photoinitiating light sources include recording light, but are not so limited.

The term “photopolymerization” refers to any polymerization reaction caused by exposure to a photoinitiating light source.

The term “free radical polymerization” refers to any polymerization reaction that is initiated by any molecule comprising a free radical or radicals.

The term “cationic polymerization” refers to any polymerization reaction that is initiated by any molecule comprising a cationic moiety or moieties.

The term “anionic polymerization” refers to any polymerization reaction that is initiated by any molecule comprising an anionic moiety or moieties.

The term “photoinitiator” refers to the conventional meaning of the term photoinitiator and also refers to sensitizers and dyes. In general, a photoinitiator causes the light initiated polymerization of a material, such as a photoactive oligomer or monomer, when the material containing the photoinitiator is exposed to light of a wavelength that activates the photoinitiator, e.g., a photoinitiating light source. The photoinitiator may refer to a combination of components, some of which individually are not light sensitive, yet in combination are capable of curing the photoactive oligomer or monomer, examples of which include a dye/amine, a sensitizer/iodonium salt, a dye/borate salt, etc.

The term “photoinitiator component” refers to a single photoinitiator or a combination of two or more photoinitiators. For example, two or more photoinitiators may be used in the photoinitiator component of the present disclosure to allow recording at two or more different wavelengths of light.

The term “polymerizable component” refers to one or more photoactive polymerizable materials, and possibly one or more additional polymerizable materials, e.g., monomers and/or oligomers, that are capable of forming a polymer.

The term “polymerizable moiety” refers to a chemical group capable of participating in a polymerization reaction, at any level, for example, initiation, propagation, etc. Polymerizable moieties include, but are not limited to, addition polymerizable moieties and condensation polymerizable moieties. Polymerizable moieties include, but are not limited to, double bonds, triple bonds, and the like.

The term “photoactive polymerizable material” refers to a monomer, an oligomer and combinations thereof that polymerize in the presence of a photoinitiator that has been activated by being exposed to a photoinitiating light source, e.g., recording light. In reference to the functional group that undergoes curing, the photoactive polymerizable material comprises at least one such functional group. It is also understood that there exist photoactive polymerizable materials that are also photoinitiators, such as N-methylmaleimide, derivatized acetophenones, etc., and that in such a case, it is understood that the photoactive monomer and/or oligomer of the present disclosure may also be a photoinitiator.

The term “photopolymer” refers to a polymer formed by one or more photoactive polymerizable materials, and possibly one or more additional monomers and/or oligomers.

The term “polymerization retarder” refers to one or more compositions, compounds, molecules, etc., that are capable of slowing, reducing, etc., the rate of polymerization while the photoinitiating light source is off or absent, or inhibiting the polymerization of the polymerizable component when the photoinitiating light source is off or absent. A polymerization retarder is typically slow to react with a radical (compared to an inhibitor); thus, while the photoinitiating light source is on, polymerization continues at a reduced rate because some of the radicals are effectively terminated by the retarder. In some embodiments, at high enough concentrations, a polymerization retarder can potentially behave as a polymerization inhibitor. In some embodiments, it is desirable to be within the concentration range that allows for retardation of polymerization to occur, rather than inhibition of polymerization.

The term “polymerization inhibitor” refers to one or more compositions, compounds, molecules, etc., that are capable of inhibiting or substantially inhibiting the polymerization of the polymerizable component when the photoinitiating light source is on or off. Polymerization inhibitors typically react very quickly with radicals and effectively stop a polymerization reaction. Inhibitors cause an inhibition time during which little to no photopolymer forms, e.g., only very small chains. Typically, photopolymerization occurs only after nearly 100% of the inhibitor is reacted.

The term “chain transfer agent” refers to one or more compositions, compounds, molecules, etc. that are capable of interrupting the growth of a polymeric molecular chain by formation of a new radical that may react as a new nucleus for forming a new polymeric molecular chain. Typically, chain transfer agents cause the formation of a higher proportion of shorter polymer chains, relative to polymerization reactions that occur in the absence of chain transfer agents. In some embodiments, certain chain transfer agents can behave as retarders or inhibitors if they do not efficiently reinitiate polymerization.

Unless otherwise stated, chemical structures depicted herein are intended to include compounds which differ only in the presence of one or more isotopically enriched atoms. For example, compounds where one or more hydrogen atoms is replaced by deuterium or tritium, or where one or more carbon atoms is replaced by ¹³C- or ¹⁴C-enriched carbons, are within the scope of this disclosure.

An “alkene” moiety refers to a group consisting of at least two carbon atoms and at least one carbon-carbon double bond, and an “alkyne” moiety refers to a group consisting of at least two carbon atoms and at least one carbon-carbon triple bond. “Alkenyl” refers to a straight or branched hydrocarbon chain radical group consisting solely of carbon and hydrogen atoms, containing at least one double bond, and having from two to ten carbon atoms (e.g., (C₂₋₁₀)alkenyl or C₂₋₁₀ alkenyl). Whenever it appears herein, a numerical range such as “2 to 10” refers to each integer in the given range—e.g., “2 to 10 carbon atoms” means that the alkenyl group may consist of 2 carbon atoms, 3 carbon atoms, etc., up to and including 10 carbon atoms. The alkenyl moiety may be attached to the rest of the molecule by a single bond, such as for example, ethenyl (e.g., vinyl), prop-1-enyl (e.g., allyl), but-1-enyl, pent-1-enyl and penta-1,4-dienyl. Unless stated otherwise specifically in the specification, an alkenyl group is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Moiety” refers to a specific segment or functional group of a molecule. Chemical moieties are often recognized chemical entities embedded in or appended to a molecule.

“Substituted” means that the referenced group may have attached one or more additional groups, radicals or moieties individually and independently selected from, for example, acyl, alkyl, alkylaryl, cycloalkyl, aralkyl, aryl, carbohydrate, carbonate, heteroaryl, heterocycloalkyl, hydroxy, alkoxy, aryloxy, mercapto, alkylthio, arylthio, cyano, halo, carbonyl, ester, thiocarbonyl, isocyanato, thiocyanato, isothiocyanato, nitro, oxo, perhaloalkyl, perfluoroalkyl, phosphate, silyl, sulfinyl, sulfonyl, sulfonamidyl, sulfoxyl, sulfonate, urea, and amino, including mono- and di-substituted amino groups, and protected derivatives thereof. The substituents themselves may be substituted, for example, a cycloalkyl substituent may itself have a halide substituent at one or more of its ring carbons. The term “optionally substituted” means optional substitution with the specified groups, radicals or moieties.

Compounds of the present disclosure also include crystalline and amorphous forms of those compounds, including, for example, polymorphs, pseudopolymorphs, solvates, hydrates, unsolvated polymorphs (including anhydrates), conformational polymorphs, and amorphous forms of the compounds, as well as mixtures thereof. “Crystalline form” and “polymorph” are intended to include all crystalline and amorphous forms of the compound, including, for example, polymorphs, pseudopolymorphs, solvates, hydrates, unsolvated polymorphs (including anhydrates), conformational polymorphs, and amorphous forms, as well as mixtures thereof, unless a particular crystalline or amorphous form is referred to.

For the avoidance of doubt, it is intended herein that particular features (for example integers, characteristics, values, uses, formulae, compounds or groups) described in conjunction with a particular aspect, embodiment or example of the disclosure are to be understood as applicable to any other aspect, embodiment or example described herein unless incompatible therewith. Thus, such features may be used where appropriate in conjunction with any of the definition, claims or embodiments defined herein. All of the features disclosed in this specification (including any accompanying claims, abstract and drawings), and/or all of the steps of any method or process so disclosed, may be combined in any combination, except combinations where at least some of the features and/or steps are mutually exclusive. The present disclosure is not restricted to any details of any disclosed embodiments.

Photolithographic techniques (including 3D printing) offer excellent spatial and temporal resolution when building polymeric objects from liquid components. However, obtaining a diverse set of desired material properties (optical, electrical, mechanical, etc.) from such techniques remains a challenge. For example, while materials with smooth gradients of properties from stiff to soft have been achieved, to some extent, materials with wide ranges of properties have largely been unattainable. The present disclosure provides an avenue for achieving 3D printable resins that produce a previously unachievable expansive range of material properties. Such resins meet the deficiencies in the field with respect to reducing the human input/machine friction.

In particular, the disclosure provides methods of patterning different regions of material (N>2) by performing a controlled series of reactions, starting with multifunctional monomers, optionally in combination with single functionality monomers. The reaction schemes include a step of spatially defining an initial polymer length from the mixture of monomers by controlling the extent of the reaction, which is typically the first polymerization step. In some instances, the step of spatially defining an initial polymer length is performed immediately following green-body formation (with respect to 3D printed materials). Following the first step, one or more additional chemical reaction steps are performed to react with remaining functional groups. This multi-material framework, which is based, at least in part and without limitation, on multiple orthogonal crosslinking reactions, enables the multi-material 3D printing of materials with different Young's modulus and surface energy, and is useful for additive manufacturing (including additive manufacturing useful in facilitating a seamless human/machine interface), adhesives, and coatings.

Novel photochemistries that enable varying material properties from within a single resin chemistry and maintain rapid multimaterial print speeds are described herein. Multicomponent resins that possess orthogonal photochemical reactions yield binary materials with discrete variations in stiffness (E_{hard}/E_{soft}˜10-10⁴). The crosslinking reactions initiate in response to different stimuli (multiple wavelengths or light and heat) to allow for localization of desired properties. Known multimaterial photochemistries include, for example, the cationic polymerization of epoxy (λ=365 nm) with free radical polymerization of acrylates (λ=405 nm), or the anionic thiol-Michael addition (λ=400-500 nm) with radical polymerization of acrylates (λ=365 nm). 3D printing such chemistries often requires additional considerations, such as the use of custom printers with multiple light sources and/or the addition of photochromic species to accentuate subtle absorption differences between photoinitiators that possess broad overlapping spectra. As an alternative, it was shown a novel dual-stage curing hybrid ink combining acrylate homopolymerization with aza-Michael reaction to achieve the single-vat grayscale DLP 4D printing.

However, all of these strategies result in materials of questionable stability. Specifically, the “soft” regions within these systems are intentionally “underpolymerized.” These voxels contain unreacted groups that continue to crosslink and stiffen under exposure to ambient light or heat. Even without additional polymerization, such unbound species can escape the polymer network and the corresponding loss in mass may result in dimensional changes (loss of resolution) of the printed object.

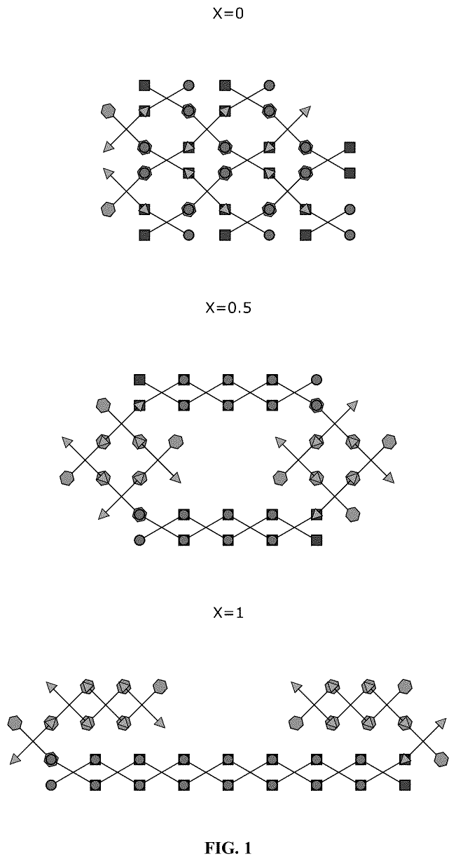

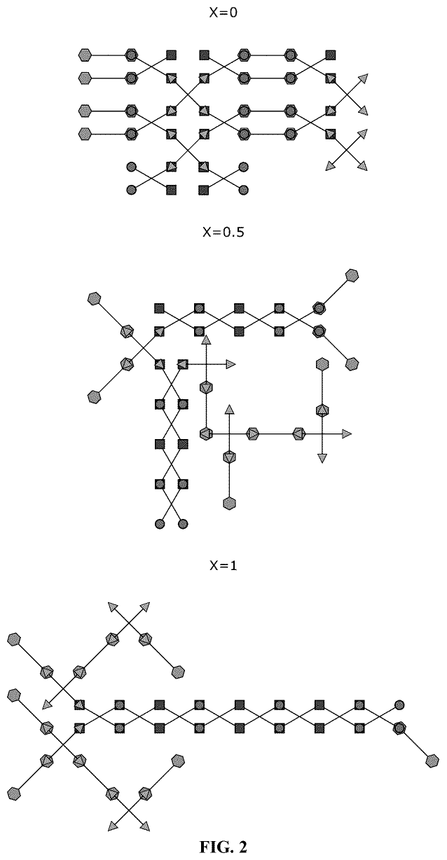

This disclosure provides a multimaterial system with stable and voxel controlled mechanical properties based on a series of orthogonal reactions. Without wishing to be bound by any particular theory, the disclosure provides a sequential reaction scheme from compatible functional groups that participate in different polymerization mechanisms based on the applied stimulus. In particular, the series of reactions commences with a step of spatially defining the initial polymer length by controlling the extent of the first reaction. The polymer length defined in the step of spatially defining the initial polymer length dictates the final material properties by occupying space and controlling the number of crosslinks in a material. As such, wide ranges of mechanical properties are accessible though this system, which is initiated with a controlled, polymer length defining reaction, as shown in FIGS. 1 and 2, which demonstrate how the impact of short photo-exposures (X˜0), medium-length photo-exposures (X˜0.5), and long photo-exposures (X˜1) on the resulting structures. In FIGS. 1 and 2, the triangle/hexagon reaction is initiated in stage one (preferred photochemistry), the hexagon-circle and triangle-square reactions are second stage reactions, and the circle-square are third stage reactions. For example, a certain number of functional groups (as represented by the shown shapes), i.e., y, can together undergo at least the same number of reactions or greater (i.e., greater than or equal to y) possible reaction pathways. This will create the reactive cascade based on stoichiometry that allows for extent reaction in the first stage to consume a precursor functional group that becomes a limiting reagent in a later stage. Thus, the extent of reaction for each stage can be controlled by controlling the extent of reaction of the initial stage.

In some embodiments, the reaction system described herein combines thiol-ene, thiol-epoxy, epoxy-epoxy, azide-alkyne, Diels-Alder, and oxime chemistry for growth polymerizations, thus forming polymer networks with disparate mechanical properties. By modulating the photoirradiation dosage, the resultant materials exhibit Young's moduli spanning three orders of magnitude (500 kPa<E_{0.2-1%}<1.6 GPa) with smooth transitions from soft and stiff regions. Unlike other photopatterned gradients, the full consumption of crosslinking groups imparts environmental (i.e., photo and thermal) stability to the final products described herein after processing. In some embodiments, the platform described herein is used to holographically and/or tomographically print monolithic 3D multimaterial structures.

Solid polymeric materials possess long chains of macromolecules held together by sufficient interactions (e.g., physical entanglements, Van der Waal forces, electrostatic forces, hydrogen bonds, and covalent bonds) between chains. In general, soft materials have weak interactions (e.g., loosely crosslinked flexible chains) while stiff materials exhibit strong interchain interactions (e.g., highly crosslinked, rigid linkages). Without wishing to be bound by any particular theory, when polymerizing a solid object from liquid precursors, reactions either add to a growing polymer backbone (increase molecular weight) or connect neighboring chains (network formation). Also without wishing to be bound by any particular theory, this distinction depends on the functionality (f), or the number of bonds a species forms during polymerization: species with f=1 are chain terminators, f=2 are chain extenders, and f>2 are crosslinkers. For a given chemistry, the functionality of the polymer building blocks and the extent of reaction (i.e., fraction of groups reacted) control the material's crosslink density and, consequently, E (Young's modulus). For stable performance, and without wishing to be bound by any particular theory, it is assumed that all reactions will eventually approach 100% conversion. In some embodiments, the modulus can be controlled by varying the functionality of the reactants.

Optionally, the chemical design can exploit the fundamental differences in stepwise addition (e.g., thiol-ene, thiol-epoxy) and chain growth (e.g., epoxy-epoxy) polymerizations. In stepwise addition, each participating chemical group reacts only once (monofunctional), often resulting in a homogeneous network. By comparison, in chain growth polymerization, each moiety forms two bonds (difunctional) and crosslinkers usually incorporate into the polymer heterogeneously. During the different phases of the reactions, regions of stiff, highly crosslinked networks can be formed (e.g., through anionic homopolymerization of the rigid diepoxy species). During other phases of the reactions, regions of soft networks can be formed (e.g., through thiol-ene and thiol-epoxy polymerizations). The structure-property relationship in the polymers resin mixtures and/or the resulting crosslinked and/or polymerized resulting materials can thus be tuned by controlling the extent of reactivity and sequence of reactivity of functional groups.

Without wishing to be bound by any particular theory, the sequencing of these reactions further influences control over each stage of curing. In some embodiments, the photoexposure dosage (Hₑ) applied during printing dictates the % conversion (X, which can have a value of 0, meaning 0% conversion, to 1, meaning 100% conversion) of functional groups and the sequence of conversion of the functional groups. Thus, without wishing to be bound by any particular theory, the photoexposure not only imparts the geometric shape of the printed object but ultimately dictates the local mechanical properties. Without wishing to be bound by any particular theory, at long photo-exposures (X˜1), the material is stiff as the more densely crosslinked, glassy epoxy network dominates. At short photo-exposures (X˜0) the large degree of chain extending thiol-epoxy reactions yields a loosely crosslinked, soft polymer. FIGS. 1 and 2 illustrate the impact of short photo-exposures (X˜0), medium-length photo-exposures (X˜0.5), and long photo-exposures (X˜1) on the resulting structures. In either case, by the end of the final stage, the process consumes nearly all functional to restrict further reaction.

In some embodiments, the initial precursor resin mixture comprises one or more monomers, the one or more monomers comprising multiple polymerizable and/or crosslinkable moieties. Optionally, the one or more monomers can include multifunctional monomers (monomers having two or more, three or more, four or more, five or more, and the like, polymerizable and/or crosslinkable moieties). Optionally, the one or more monomers can include single functionality monomers (monomers having a single polymerizable and/or crosslinkable moiety).

In some embodiments, a polymerizable or crosslinkable moiety is an alkene group, e.g., and without limitation, vinyl, allyl, acrylate, methacrylate, or the like. Optionally, a polymerizable or crosslinkable moiety is a terminal alkene group. Optionally, a polymerizable or crosslinkable moiety is a diene group (e.g., and without limitation, a conjugated diene). In some embodiments, a polymerizable or crosslinkable moiety is an alkyne group. In some embodiments, a polymerizable or crosslinkable moiety is a nucleophilic group, e.g., and without limitation, thiol, azide, or the like. In one embodiment, a polymerizable or crosslinkable moiety is a strained three membered ring heterocycle, e.g., and without limitation, epoxy or thiirane. In one embodiment, a polymerizable or crosslinkable moiety is an oxime group.

In some embodiments, the one or more intermediate stage reactive conversions comprise at least one group selected from —S— and —S—CH₂—CH(OH)—. In some embodiments, the one or more intermediate stage reactive conversions comprise at least one group selected from —S—, —S—CH₂— CH(OH)—, and —CH₂—CH(−)—O—. In some embodiments, the polymeric material comprises at least one group selected from —S—, —S—CH₂—CH(OH)—, and —CH₂—CH(−)—O—. In some embodiments, the polymeric material comprises the groups —S—, —S—CH₂—CH(OH)—, and —CH₂—CH(−)—O—.

In some embodiments, the one or more monomers are selected from a monofunctional monomer, a bifunctional monomer, a trifunctional monomer, and a tetrafunctional monomer. In some embodiments, the one or more monomers are selected from BisDE, TATATO, GDMP, and PETMP, as shown below.

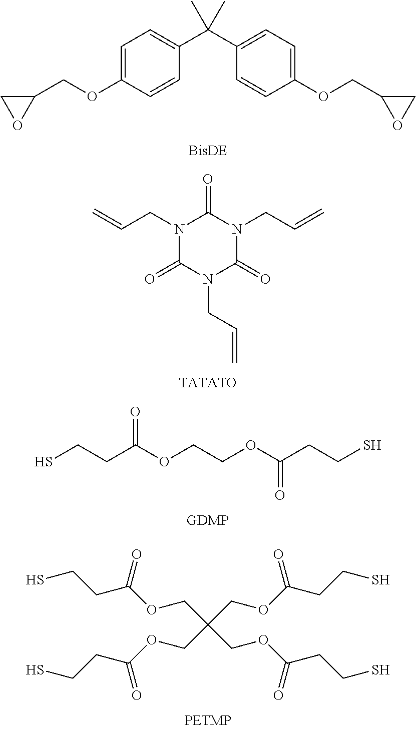 [SMILES: CC(C)(c1ccc(OCC2CO2)cc1)c1ccc(OCC2CO2)cc1 ; C=CCn1c(=O)n(CC=C)c(=O)n(CC=C)c1=O ; O=C(CCS)OCCOC(=O)CCS ; O=C(CCS)OCC(COC(=O)CCS)(COC(=O)CCS)COC(=O)CCS]

In some embodiments, the one or more monomers are selected from BisDE, TATATO, GDMP, PETMP, allyl glycidyl ether, tris 2-(acryloyloxy) ethyl isocyanurate, 1,3,5-triacryloylhexahydro-1,3,5-triazine, pentaerythritol tetra(3-mercaptopropionate), trimethylolpropane tris(3-mercaptopropionate), and 1,6-hexanedithiol. In some embodiments, the one or more monomers are selected from epoxy monomers such as allyl glycidyl ether, 1,3-butadiene diepoxide, diglycidyl 1,2-cyclohexanedicarboxylate, 1,2-epoxy-5-hexene, 2-methyl-2-vinyloxirane, resorcinol diglycidyl ether, tris(2,3-epoxypropyl) isocyanurate, 3,4-epoxycyclohexylmethyl 3,4-epoxycyclohexanecarboxylate. In some embodiments, the one or more monomers are selected from any epoxy, glycidyl ether, and/or epoxycyclohexanecarboxylate known in the art. In some embodiments, the one or more monomers are selected from alkene monomers such as diallyl ether, diallyl terephthalate, diallyl carbonate, acrylates, methacrylates, di-norbornenes, tri-norbornenes, 2,4,6-triallyloxy-1,3,5-triazine, tris 2-(acryloyloxy) ethyl isocyanurate, and 1,3,5-triacryloylhexahydro-1,3,5-triazine. In some embodiments, the one or more monomers are selected from thiol monomers such as 2,5-dimercaptomethyl-1,4-dithiane, 2,3-dimercapto-1-propanol, 2-mercapto-ethyl sulfide, 2,3-(dimercaptoethylthio)-1-mercaptopropane, 1,2,3-trimercaptopropane, ethylene glycol bis(thioglycolate), ethylene glycol bis(3-mercaptopropionate), pentaerythritol tetra(3-mercaptopropionate), trimethylolpropane tris(3-mercaptopropionate), pentaerythritol tetra(2-mercaptoacetate), trimethylolpropane tris(2-mercaptoacetate), 1,6-hexanedithiol, 1,2-benzenedithiol, 1,3-benzenedithiol, isophorone diurethane thiol, and the like.

In some embodiments, the one or more monomers include one or more terminal groups selected from hydrogen, optionally substituted alkyl, optionally substituted heteroalkyl, optionally substituted alkenyl, optionally substituted alkynyl, optionally substituted cycloalkyl, optionally substituted heterocycloalkyl, optionally substituted aryl, optionally substituted arylalkyl, optionally substituted heteroaryl, optionally substituted heteroarylalkyl, optionally substituted acrylate, optionally substituted methacrylate, optionally substituted styrene, optionally substituted epoxide, optionally substituted thiirane, optionally substituted glycidyl, optionally substituted lactone, optionally substituted carbonate, hydroxy, halo, cyano, trifluoromethyl, trifluoromethoxy, nitro, and trimethylsilanyl. In some embodiments, the one or more terminal groups are selected from alkenyl, cycloalkenyl, optionally substituted aryl, and optionally substituted heteroaryl. In some embodiments, the one or more terminal groups are selected from optionally substituted acrylate, optionally substituted methacrylate, optionally substituted vinyl, optionally substituted epoxide, optionally substituted thiirane, optionally substituted glycidyl, and optionally substituted allyl. In some embodiments, the one or more terminal groups are selected from vinyl, allyl, thiol, alcohol, epoxide, thiirane, glycidyl, acrylate, and methacrylate. In some embodiments, the one or more terminal groups are selected from optionally substituted thiophenyl, optionally substituted thiopyranyl, optionally substituted thienothiophenyl, and optionally substituted benzothiophenyl. In some embodiments, the one or more terminal groups are selected from vinyl, thiol, and epoxide (i.e., epoxy).

In some embodiments, the one or more monomers include one or more compounds comprising a polymerizable or crosslinkable group selected from optionally substituted alkenyl, optionally substituted cycloalkenyl, optionally substituted alkynyl, optionally substituted acrylate, optionally substituted methacrylate, optionally substituted styrene, optionally substituted epoxide, optionally substituted thiirane, optionally substituted glycidyl, optionally substituted lactone, optionally substituted lactam, and optionally substituted carbonate. In some embodiments, the polymerizable or crosslinkable group is selected from vinyl, allyl, epoxide, thiol, thiirane, glycidyl, acrylate, and methacrylate.

In some embodiments, the initial precursor resin mixture comprises one or more radical photoinitiators selected from 2,2-dimethoxy-1,2-diphenylethan-1-one, bis(2,4,6-trimethylbenzoyl)-phenylphosphineoxide, 1-hydroxycyclohexyl benzophenone, trimethyl-benzoyl-diphenyl-phosphine-oxide, but any radical photoinitiator known in the art can be used without limitation.

In some embodiments, the initial precursor resin mixture comprises one or more base catalysts selected from imidazole, allyl 1H-imidazole-1-carboxylate, isopropyl 1H-imidazole-1-carboxylate, 1-(3-aminopropyl)imidazole, 1-(diethoxymethyl)imidazole, Technicure® LC-80, LC-100, Technicure® D, D-5, D-10, D-44, Nano, but any base catalyst known in the art can be used without limitation.

In some embodiments, the one or more polymerization and/or crosslinking stimuli are selected from subjecting the initial precursor resin mixture and/or any of the intermediate stage reactive conversions to a light source, a raised temperature (e.g., through a heat source), and/or ultrasound. In some embodiments, a polymerization and/or crosslinking stimulus is subjecting the initial precursor resin mixture to a light source. In some embodiments, a polymerization and/or crosslinking stimulus is subjecting the initial precursor resin mixture to a raised temperature (a heat source). In some embodiments, a polymerization and/or crosslinking stimulus is subjecting the initial precursor resin mixture to ultrasound.

In some embodiments, the polymerization and/or crosslinking stimuli include subjecting any of the intermediate stage reactive conversions to a light source. Optionally, the wavelength of light can be sequentially increased or decreased, such that the polymerization and/or crosslinking stimuli include subjecting any of the intermediate stage reactive conversions to a first wavelength of light, a second wavelength of light, a third wavelength of light, a fourth wavelength of light, a fifth wavelength of light, a sixth wavelength of light, a seventh wavelength of light, an eighth wavelength of light, a ninth wavelength of light, a tenth wavelength of light, or the like. In some embodiments, the polymerization and/or crosslinking stimuli are selected from subjecting any of the intermediate stage reactive conversions to at least two different wavelengths of light (e.g., two different wavelengths of light, three different wavelengths of light, four different wavelengths of light, five different wavelengths of light, six different wavelengths of light, seven different wavelengths of light, eight different wavelengths of light, nine different wavelengths of light, or ten or more different wavelengths of light).

In some embodiments, the polymerization and/or crosslinking stimuli include subjecting any of the intermediate stage reactive conversions to a raised temperature. Optionally, the raised temperature can be sequentially increased (or decreased, albeit higher than room temperature and thus, still a raised temperature), such that the polymerization and/or crosslinking stimuli include subjecting any of the intermediate stage reactive conversions to a first raised temperature, a second raised temperature, a third raised temperature, a fourth raised temperature, a fifth raised temperature, a sixth raised temperature, a seventh raised temperature, an eighth raised temperature, a ninth raised temperature, a tenth raised temperature, or the like. In some embodiments, the polymerization and/or crosslinking stimuli are selected from subjecting any of the intermediate stage reactive conversions to at least two different raised temperatures (e.g., two different raised temperatures, three different raised temperatures, four different raised temperatures, five different raised temperatures, six different raised temperatures, seven different raised temperatures, eight different raised temperatures, nine different raised temperatures, or ten or more different raised temperatures).

In some embodiments, a raised temperature is between about 50° C. and about 175° C. In some embodiments, a raised temperature is between about 50° C. and about 100° C. In some embodiments, a raised temperature is between about 75° C. and about 85° C. In some embodiments, a raised temperature is about 50° C. In some embodiments, a raised temperature is about 55° C. In some embodiments, a raised temperature is about 60° C. In some embodiments, a raised temperature is about 65° C. In some embodiments, a raised temperature is about 70° C. In some embodiments, a raised temperature is about 75° C. In some embodiments, a raised temperature is about 80° C. In some embodiments, a raised temperature is about 85° C. In some embodiments, a raised temperature is about 90° C. In some embodiments, a raised temperature is about 95° C. In some embodiments, a raised temperature is about 100° C. In some embodiments, a raised temperature is between about 100° C. and about 150° C. In some embodiments, a raised temperature is about 80° C., about 90° C., about 100° C., about 110° C., about 120° C., about 130° C., about 140° C., about 150° C., about 160° C., about 170° C., or about 175° C. Any of the aforementioned raised temperatures can be used for any of the raised temperatures of the method, including the first, the second, the third, the fourth, the fifth, the sixth, the seventh, the eighth, the ninth, or the tenth (or more) raised temperature. Optionally, a ramp rate from any given raised temperature to the next raised temperature (e.g., from the first raised temperature to the second raised temperature, from the second raised temperature to the third raised temperature, and the like) is about 0.5° C./min to about 20° C./min.

In some embodiments, the polymerization and/or crosslinking stimuli include subjecting any of the intermediate stage reactive conversions to ultrasound. Optionally, the wavelength of light can be sequentially increased or decreased, such that the polymerization and/or crosslinking stimuli include subjecting any of the intermediate stage reactive conversions to a first ultrasound frequency, a second ultrasound frequency, a third ultrasound frequency, a fourth ultrasound frequency, a fifth ultrasound frequency, a sixth ultrasound frequency, a seventh ultrasound frequency, an eighth ultrasound frequency, a ninth ultrasound frequency, a tenth ultrasound frequency, or the like. In some embodiments, the polymerization and/or crosslinking stimuli are selected from subjecting any of the intermediate stage reactive conversions to at least two different ultrasound frequencies (e.g., two different ultrasound frequencies, three different ultrasound frequencies, four different ultrasound frequencies, five different ultrasound frequencies, six different ultrasound frequencies, seven different ultrasound frequencies, eight different ultrasound frequencies, nine different ultrasound frequencies, or ten or more different ultrasound frequencies).

The staged curing described herein allows graduate change of the mechanical properties and provide relative large gradient of the modulus difference.

The multimaterial system disclosed herein provides stable mechanical properties under light and elevated temperature since all reactive moieties are consumed by the thermal curing process.

In some embodiments, the initial precursor resin mixture further comprises a photoinitiator. In some embodiments, the modulus is selected from Young's modulus (E), shear modulus or modulus of rigidity (G), and bulk modulus (K). In some embodiments, the modulus is Young's modulus (E). In some embodiments, the modulus is storage modulus and/or loss modulus. In some embodiments, the method is a 3D printing method.

In some embodiments, the initial precursor resin mixture further comprises a photoinitiator. The photoinitiator chemically initiates the polymerization of a photoactive polymerizable material. The photoinitiator generally should offer a source of species that initiate polymerization of the particular photoactive polymerizable material, e.g., photoactive monomer. Typically, from about 0.1 to about 20 vol. % photoinitiator provides desirable results. A variety of photoinitiators known to those skilled in the art and available commercially are suitable for use as described herein, for example, those comprising a phosphine oxide group, such as diphenyl(2,4,6-trimethylbenzoyl)phosphine oxide, disclosed in U.S. Pat. No. 6,780,546 (Trentler et al.), issued Aug. 24, 2004, incorporated herein by reference. In some embodiments, the photoinitiator is sensitive to light at wavelengths available from conventional laser sources, e.g., the blue and green lines of Ar⁺ (458, 488, 514 nm) and He—Cd lasers (442 nm), the green line of frequency doubled YAG lasers (532 nm), and the red lines of He—Ne (633 nm), Kr⁺ lasers (647 and 676 nm), and various diode lasers (290 to 900 nm). In some embodiments, the free radical photoinitiator bis(η-5-2,4-cyclopentadien-1-yl)bis[2,6-difluoro-3-(1H-pyrrol-1-yl)phenyl]titanium can be used. In some embodiments, the free-radical photoinitiator 5,7-diiodo-3-butoxy-6-fluorone can be used. In some embodiments, this photoinitiator requires a co-initiator. Free-radical photoinitiators of dye-hydrogen donor systems can also be used. Examples of suitable dyes include eosin, rose bengal, erythrosine, and methylene blue, and suitable hydrogen donors include tertiary amines such as n-methyl diethanol amine. In the case of cationically polymerizable components, a cationic photoinitiator is used, such as a sulfonium salt or an iodonium salt.

These cationic photoinitiator salts absorb predominantly in the UV portion of the spectrum, and are therefore typically sensitized with a sensitizer or dye to allow use of the visible portion of the spectrum. An example of an alternative visible cationic photoinitiator is (η₅-2,4-cyclopentadien-1-yl) (η₆-isopropylbenzene)-iron(II) hexafluorophosphate. In some embodiments, photoinitiators used herein are sensitive to ultraviolet and visible radiation of from about 200 nm to about 800 nm. In some embodiments, other additives can be used in the photoimageable system, e.g., inert diffusing agents having relatively high or low refractive indices.

In some embodiments, a polymer article described herein may also include additives such as plasticizers for altering the properties of the article of the present disclosure including the melting point, flexibility, toughness, diffusibility of the monomers and/or oligomers, and ease of processability. Examples of suitable plasticizers include dibutyl phthalate, poly(ethylene oxide) methyl ether, N,N-dimethylformamide, etc. Plasticizers differ from solvents in that solvents are typically evaporated whereas plasticizers are meant to remain in the article.

Other types of additives that may be used in a resin mixture and article of the present disclosure are inert diffusing agents having relatively high or low refractive indices. Other additives that may be used in a resin mixture and article of the present disclosure include: pigments, fillers, nonphotoinitiating dyes, antioxidants, bleaching agents, mold releasing agents, antifoaming agents, infrared/microwave absorbers, surfactants, adhesion promoters, etc.

Suitable polymerization retarders and inhibitors for use herein include but are not limited to one or more of the following: for free radical polymerizations, various phenols including butylated hydroxytoluenes (BHT) such as 2,6-di-t-butyl-p-cresol, p-methoxyphenol, diphenyl-p-benzoquinone, benzoquinone, hydroquinone, pyrogallol, resorcinol, phenanthraquinone, 2,5-toluquinone, benzylaminophenol, p-dihydroxybenzene, 2,4,6-trimethylphenol, etc.; various nitrobenzenes including o-dinitrobenzene, p-dinitrobenzene, m-dinitrobenzene, etc.; N-phenyl-1-naphthylamine, N-phenyl-2-naphthylamine, cupferron, phenothiazine, tannic acid, p-nitrosamine, chloranil, aniline, hindered anilines, ferric chloride, cupric chloride, triethylamine, etc. These polymerization retarders and inhibitors can be used individually (e.g., a single retarder) or in combinations of two or more, e.g., a plurality of retarders. The same principles can be applied to ionic polymerizations. For example, it is known that chloride anions can behave as retarders or inhibitors for cationic polymerizations, depending on both the monomer type and the concentration of the chloride anions. Typically, functionalities that are basic or mildly nucleophilic behave as retarders and inhibitors for cationic polymerizations; whereas for anionic polymerizations, slightly acidic and mildly electrophilic functionalities behave as retarders and inhibitors.

In some embodiments, polymerization reactions involving both polymerization retarders and inhibitors should lead to termination reactions. If reinitiation occurs to any appreciable degree, then the agent is typically considered a chain transfer agent. For example, triethylamine can be used as a chain transfer agent since it is also capable of reinitiating some radical polymerizations; however, when the reinitiation is slow compared to termination reactions, then even chain transfer agents can be considered potential polymerization retarders or inhibitors for the purposes of the present disclosure. Suitable chain transfer agents for use herein include but are not limited to: triethylamine, thioethers, compounds having carbonate groups, ethers, toluene derivatives, allyl ethers, etc. Chain transfer agents that are mildly retarding can be desirable because these can be incorporated into the matrix and enable attachment of the photopolymer and photoinitiator radicals to the matrix.

In addition to retarders, inhibitors and/or chain transfer agents, metastable reactive centers and light labile phototerminators can also be used to control polymerization reactions described herein of the appropriate reactivity. For example, nitroxyl radicals can be added as a metastable reactive center. Nitroxyl radicals create pseudo-living radical polymerizations with certain monomers. Thus, the nitroxyl radical initially behaves as a terminating agent (such as an inhibitor); however, depending on the temperature at which the polymerization is carried out, the termination is reversible. Other potential metastable reactive center include triphenylmethyl radicals, dithioesters are typically used in Reversible Addition-Fragmentation chain Transfer (RAFT) polymerizations, that can behave as appropriate metastable reactive centers, etc. As for ionic polymerizations, there are stable ions that are able to perform the same function, as the example nitroxyl radicals above.

Use of a light labile phototerminator provides the ability to control the activity of the reactive species with light (as opposed to heat as described herein). A light labile phototerminator is any molecule capable of undergoing reversible termination reactions using a light source. For example, certain cobaltoxime complexes can be used to photoinitiate radical polymerizations, and yet, also terminate the same radical polymerizations.

Dithioesters are also suitable as light labile phototerminators because they have the ability to reversibly form radicals with appropriate wavelengths of light. Under the appropriate conditions and with appropriate monomers (such as styrenes and acrylates), it is possible to restart the polymerization by irradiating with a photoinitiating light source (e.g., recording light). Thus, as long as a given volume is exposed to a photoinitiating light source, radical polymerization continues, whereas when the photoinitiating light is off or absent, the polymerizations are terminated. Metastable reactive centers and light labile phototerminators can also be used to control ionic (e.g., cationic or anionic initiated) polymerization reaction systems according to the present disclosure.

For ionic chain reactions (e.g., cationic and anionic initiated polymerization reactions), counter ion and solvent effects can be used to control polymerization by terminating the reactive center. Ionic systems are sensitive to solvent conditions because the solvent (or the support matrix) determines the proximity of the counter ion to the reactive center. For instance, in a nonpolar medium the counter ion will be very closely associated with the reactive center; in a polar medium the counter ion may become freely dissociated. The proximity of the counter ion can determine polymerization rate as well as the potential for collapse with the counter ion (depending on the counter ion used). For example, if one uses a cationic polymerization with a nonpolar support matrix and chloride anion as the counter ion, there is a better probability of terminating the reaction due to collapse of the counter ion.

Certain monomer mixtures can also behave in a manner that can control the degree or rate of polymerization. For example, if a small amount of alpha methyl styrene is present in an acrylate polymerization, the acrylate will add into the alpha methyl styrene and the styrene will not substantially reinitiate polymerization of the acrylate, e.g., the alpha methyl styrene retards the rate of acrylate polymerization. Additionally, the alpha methyl styrene is slow to polymerize with itself, and thus behaves as a polymerization retarder/inhibitor even though it is a comonomer. In the case of ionic polymerizations; using, for example, vinyl anisole in a cationic vinyl ether polymerization results in retarded rates of polymerization because the vinyl anisole does not efficiently reinitiate vinyl ether polymerization.

The disclosure also provides a polymeric material having at least one modulus gradient in a spatial direction, the polymeric material made by a method described herein.

The disclosure also provides a polymeric material having a modulus gradient over one spatial direction, wherein modulus is measured in a plurality of voxels. Voxel refers to a volumetric pixel, or the smallest unit of discrete 3D space that can be selectively illuminated, e.g., selectively illuminated by a light source such as a 3D printer light source.

Without wishing to be bound by any particular theory, in some embodiments, a voxel is about 800 nm in each dimension (2×405 nm excitation due to diffraction limit).

In some embodiments, the modulus is selected from Young's modulus (E; which is also referred to as elastic modulus), shear modulus or modulus of rigidity (G), and bulk modulus (K). In some embodiments, the modulus is Young's modulus (E). In some embodiments, the modulus is storage modulus and/or loss modulus. In some embodiments, the modulus ranges from about 10² to about 10¹⁰ Pa. In some embodiments, the modulus ranges from about 10² to about 10¹⁰ Pa. In some embodiments, the modulus ranges from about 10⁵ to about 10¹⁰ Pa. In some embodiments, the modulus ranges from about 10³ to about 10⁵ Pa.

In some embodiments, the modulus gradient is between values having the same degree of magnitude. In some embodiments, the modulus gradient is between values one degree of magnitude apart. In some embodiments, the modulus gradient is between values two degrees of magnitude apart. In some embodiments, the modulus gradient is between values three degrees of magnitude apart. In some embodiments, the modulus gradient is between values four degrees of magnitude apart. In some embodiments, the modulus gradient is between values five degrees of magnitude apart. In some embodiments, the modulus gradient is between values six degrees of magnitude apart. Modulus can be measured by atomic force microscopy (AFM) with sub 10 nm resolution in any dimension.

The compositions and methods of the appended claims are not limited in scope by the specific compositions and methods described herein, which are intended as illustrations of a few aspects of the claims and any compositions and methods that are functionally equivalent are within the scope of this disclosure. Various modifications of the compositions and methods in addition to those shown and described herein are intended to fall within the scope of the appended claims. Further, while only certain representative compositions, methods, and aspects of these compositions and methods are specifically described, other compositions and methods are intended to fall within the scope of the appended claims. Thus, a combination of steps, elements, components, or constituents can be explicitly mentioned herein; however, all other combinations of steps, elements, components, and constituents are included, even though not explicitly stated.

What is claimed is:

1. A method of polymerizing functionalized monomers, comprising:
subjecting an initial precursor resin mixture to an external stimulus, wherein the initial precursor resin mixture comprises one or more monomers, the one or more monomers comprising multifunctional monomers comprising two or more functional groups, to generate an intermediate stage reactive conversion having a spatially defined initial polymer length; and
subjecting the intermediate stage reactive conversion to one or more polymerization and/or crosslinking stimuli,
wherein the method steps are performed in a single reactor.

2. The method of claim 1, wherein the two or more functional groups are each independently selected from the group consisting of an alkene, a thiol, an azide, a diene, or an oxime.

3. The method of claim 1, wherein the multifunctional monomer comprises a bifunctional monomer, a trifunctional monomer, or a tetrafunctional monomer.

4. The method of claim 1, wherein the initial precursor resin mixture further comprises a single-functionality monomer having one functional group.

5. The method of claim 4, wherein the one functional group is selected from the group consisting of an alkene, a thiol, an azide, a diene, or an oxime.

6. The method of claim 1, wherein the external stimulus is a light source.

7. The method of claim 1, wherein the external stimulus is a raised temperature.

8. The method of claim 7, wherein the raised temperature is from about 50° C. and about 175° C.

9. The method of claim 1, wherein the external stimulus is ultrasound.

10. The method of claim 1, wherein the one or more polymerization and/or crosslinking stimuli is a light source.

11. The method of claim 1, wherein the one or more polymerization and/or crosslinking stimuli is a raised temperature.

12. The method of claim 11, wherein the raised temperature is from about 50° C. and about 175° C.

13. The method of claim 11, wherein the polymerization and/or crosslinking stimuli comprise to at least two different raised temperatures.

14. The method of claim 1, wherein the initial precursor resin mixture further comprises a photoinitiator.

15. The method of claim 1, wherein the intermediate stage reactive conversion is partially crosslinked or polymerized.

16. The method of claim 1, wherein the method is a 3D printing method.

17. A polymeric material made by a method of claim 1.

18. The polymeric material of claim 17, having a modulus gradient in a spatial direction.

19. The polymeric material of claim 18, wherein the modulus gradient is an elastic modulus gradient.

20. The polymeric material of claim 18, wherein the modulus ranges from 10² Pa to 10¹⁰ Pa.
